(19) United States
(12) Patent Application Publication
(10) Pub. No.: US 2006/0018998 A1
(43) Pub. Date: Jan. 26, 2006

(54) Methods of providing consumers with a recognizable nutritional identifier

(76) Inventors: Nancy R. Green, Chicago, IL (US); Ellen C. Taaffe, Wilmette, IL (US)

Correspondence Address: Cook, Alex, McFarron, Manzo, Cummings & Mehler, Suite 2850, 200 West Adams, Chicago, IL, 60606, US

(21) Appl. No.: 10/895,744

(22) Filed: Jul. 21, 2004

(51) Int. Cl. A22C 17/10

(52) U.S. Cl. 426/87

(57) ABSTRACT

Methods for providing consumers with nutritional value information of a food product include developing threshold criteria related to nutritional value information, selecting food products satisfying all of the threshold criteria, applying a distinctive logo to the selected food products, and distributing and displaying the food products with the distinctive logo. Other methods of developing threshold criteria include developing criteria for food products with at least one ingredient having an efficacious effect and developing criteria for food products having a minimum reduction of nutritionally negative food components. Analysis of whether food products satisfy all applicable criteria may be automated in a data processing system.

### FIELD OF THE INVENTION

The present invention relates generally to food products and nutrition. More particularly, the invention relates to methods for providing readily recognizable nutritional information to consumers.

### BACKGROUND OF THE INVENTION

The Food and Drug Administration (FDA) has previously established standards for labeling of food products, including beverages and snacks, as “Healthy”. For example, the criteria for healthy include less than 3 mg of fat, less than 1 mg of saturated fat, no more than 60 mg of cholesterol, no more than 480 mg of sodium. In addition, if the food product is identified as having reduced sugar, the sugar content must be no greater than 25%. The healthy food products also contain 10% or more of the recommended daily requirements of vitamins A and C, iron, fiber and protein. However, the FDA standards do not have any criteria or limits for trans fats or for added sugar.

The National Academy of Sciences (NAS) has issued dietary recommendations, which include no more that 20-35% of kcal for fats, low saturated fats, low trans fats and up to 25% of kcal for added sugar.

As noted above, the FDA and NAS standards provide some guidelines for food products and diets, but neither standard provides a comprehensive set of limits for food product contents, especially those food product contents that are known to be potentially detrimental to health. It is therefore difficult for consumers to know whether, or to understand to what extent, they ought to rely upon a claim that a food product supports a healthy lifestyle.

It has come to be appreciated by the present inventors that advantages can be realized by standards for food products that are healthy, are of reduced sugar or calorie content or that deliver a functional benefit. It also has come to be realized that further advantages could be gained by providing a marking, such as a with a logo, that will be readily recognizable by consumers to represent or to certify that the identified food product satisfies a comprehensive list of limitations for food ingredients known to be detrimental to health and for supplementation of food ingredients known to provide a biologically efficacious effect.

Accordingly, it is a general aspect or object of the present invention to provide indicia on the packaging of a food product that will alert the consumer that the food product of interest satisfies certain nutritional criteria.

Yet another aspect or object of the present invention is to provide indicia on the packaging of food products that indicate that the food product has been fortified with healthy ingredients, such as vitamins, iron, fiber and/or protein.

### BRIEF SUMMARY OF THE INVENTION

The present invention is directed to a method for providing consumers with nutritional value information, including the steps of developing threshold criteria for nutritional value information, the threshold criteria including a maximum fat level, a maximum saturated fat level, a maximum trans-fat level, a maximum cholesterol level, a maximum sodium level, and a maximum percentage of calories from sugars, selecting food products exhibiting all of the threshold criteria, the food products being selected from among products of a company, applying a distinctive logo to the food products that exhibit the threshold criteria to provide a plurality of nutritional value food products; and distributing the nutritional value food products for display in retail store outlets with the distinctive logo being visible to retail consumers.

The food products may be selected from the group consisting of beverages, solid foods and snack foods and the selection process may be automated. The step of developing threshold criteria may include the step of developing a maximum fat level criteria selected from the group consisting of (a) containing about 3 grams of fat or less and (b) having not more than about 35 percent of its calories from fat, based upon the total calories provided by the food product. The step of developing threshold criteria may use a maximum saturated fat level of less than about 1 gram or less of saturated fat, a maximum trans-fat level of zero, a maximum cholesterol level of 60 milligrams or less of cholesterol, a maximum sodium level of 480 milligrams or less of sodium, and a maximum percentage of calories from sugar of not more than about 25 percent of the calories of the food product being from sugar, based upon the total calories provided by the food product. The step of developing threshold criteria may also include recognizing vitamins, minerals, fiber, protein, or combinations thereof.

The present invention also includes another method for providing consumers with nutritional value information, including the steps of developing threshold criteria for nutritional value information for food products, the threshold criteria being that the food product includes a nutritional ingredient selected from the group consisting of fortified ingredients and ingredients naturally present in the food product, the nutritional ingredient being efficacious in delivering a biologically functional benefit when ingested, selecting food products exhibiting the threshold criteria, the food products being selected from among products of a company, applying a distinctive logo to the food products that exhibit the threshold criteria to provide a plurality of nutritional value food products, and distributing the nutritional value food products for displaying same in retail store outlets with the distinctive logo being visible to retail consumers. The food products may generally include beverages, solid foods and snack foods.

Another method of the present invention provides consumers with nutritional value information by developing threshold criteria for nutritional value information, the threshold criteria being a minimum reduction in a nutritionally negative component selected from the group consisting of fat level, sugar level, sodium level, total calorie level, and combinations thereof, each minimum level being reduced when compared with a base product which is formulated with a traditional level of the nutritionally negative component, selecting food products exhibiting at least one of the threshold criteria, the food products being selected from among products of a company, applying a distinctive logo to the food products that exhibit the threshold criteria to provide a plurality of nutritional value food products, and distributing the nutritional value food products for display in retail store outlets with the distinctive logo being visible to retail consumers.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the figures in which like reference numerals identify like elements, and in which:

FIGS. 1A and 1B are flow charts illustrating a first method for developing threshold criteria for the nutritional value of a food product in accordance with the present invention;

FIG. 2 is a flow chart illustrating further detail for the step of selecting a food product in the method for developing threshold criteria for nutritional value as shown in the flow chart of FIGS. 1A and 1B;

FIG. 3 is a diagrammatic view of a logo that may be applied to a food product that satisfies one or more of the methods for analyzing food products in accordance with the methods of the present invention;

FIG. 4 is a perspective view of a display stand for displaying containers to potential consumers the distinctive logo applied to those food products that satisfy the criteria of one or more methods of the present invention;

FIGS. 5A and 5B are flow charts of a second method for developing threshold criteria for the nutritional value of a food product in accordance with the present invention;

FIGS. 6A and 6B are flow charts of a third method for developing threshold criteria for a minimum reduction of a nutritionally negative component in a food product in accordance with the present invention;

FIG. 7 is a flow chart of a fourth method for developing threshold criteria for a functional benefit in a food product in accordance with the present invention;

FIG. 8 is a diagrammatic view of a data processing system for receiving data on the criteria for selection of food products, for receiving information on the ingredients in selected food products and for analyzing the nutritional value of a selected food product in accordance with the appropriate selection criteria to determine if the selected food product meets the criteria for application of the distinctive logo; and

FIGS. 9A and 9B are flow charts of typical steps for automated selection of food products, such as by the data processing system of FIG. 8, for any of the methods of FIGS. 1A-1B, 5A-5B, 6A-6B or 7.

### DESCRIPTION OF THE PREFERRED EMBODIMENT

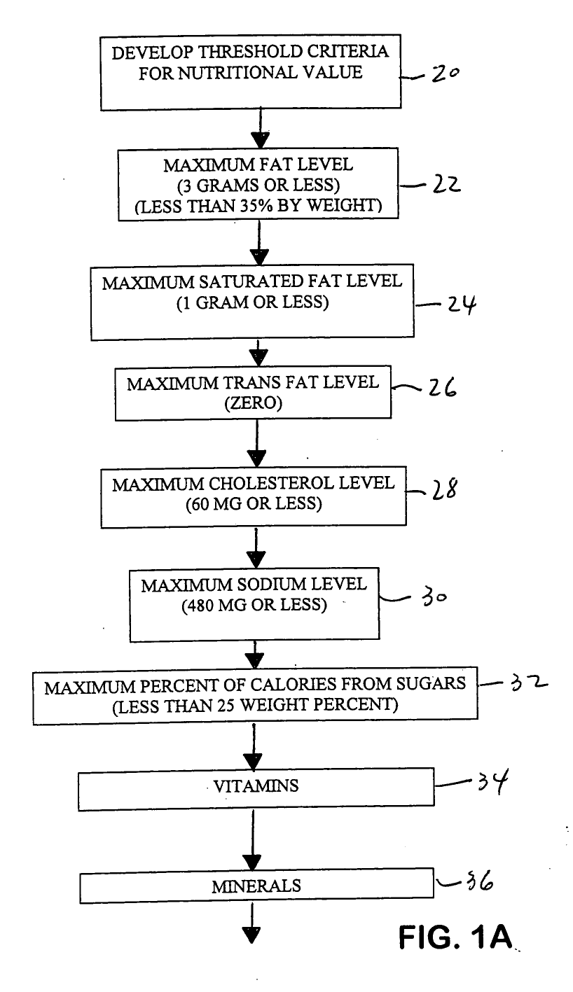

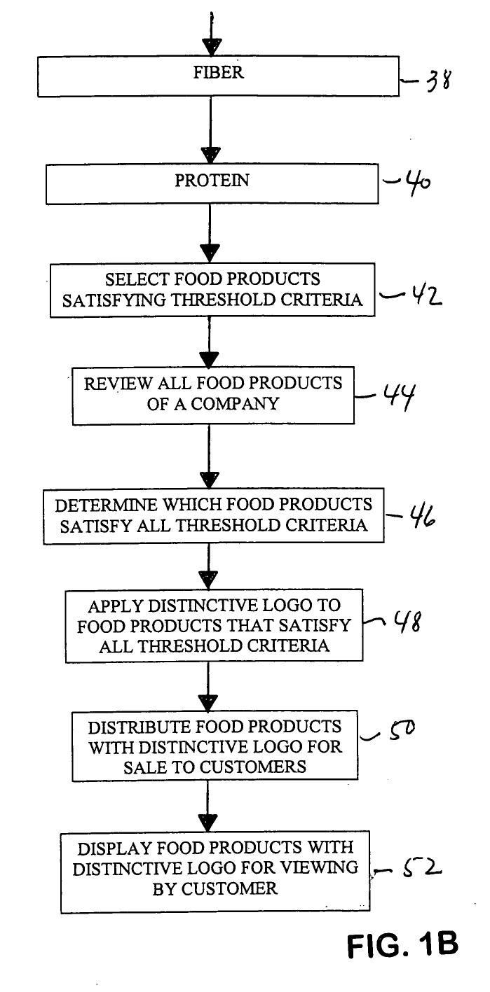

A first method of developing threshold criteria for nutritional value of one or more food products in accordance with the present invention is shown in FIGS. 1A and 1B, and begins at block 20 in FIG. 1A. As will be better appreciated below, the criteria developed in this first method, or any of the other methods disclosed below, will be used to analyze selected food products to determine which food products satisfy all of the criteria. Those food products that satisfy all of the criteria of any of the methods of the present invention may be marked with a distinctive logo to alert or to advise a consumer that the marked food product satisfies criteria of a defined nutritional value. Such marked food products will then be displayed for sale, such as in commercial establishments including grocery stores, discount stores, or the like, where the consumer will learn to recognize and appreciate the significance of the distinctive logo on any food products.

At block 22 in FIG. 1A, the initial criterion may be a definition of the maximum fat level in a food product. In this example, the maximum fat level is defined as about 3 grams or less. Alternatively, the maximum fat level may be defined as about less than 35 percent by weight, especially for a food product that has a little weight in a typical serving.

A second criterion associated with the first method may include a definition of the maximum saturated fat level of the food product, such as about one gram or less, as indicated in block 24 of FIG. 1A. A third criterion may include a maximum trans fat level of about zero, as shown in block 26. Preferably, the first method also includes a criterion for the maximum cholesterol level of the food product, such as about 60 mg, or less, as indicated in block 28. Yet another criterion defining the maximum sodium level of the food product at about 480 mg, or less, is indicated in block 30. The first method may also include a definition of the maximum percent of calories from sugars (block 32), which may be about less than 25 weight percent.

As further illustrated in FIGS. 1A and 1B, the first method of the present invention also preferably includes criteria for minimum percentages of the daily requirements for vitamins in block 34. This may include, for example, minimum percentages for vitamin A, vitamin C, and the like. As indicated at block 36, threshold criteria for nutritional value may also include minimum percentages of the daily requirements for certain minerals, such as iron, calcium, and the like. At block 38, the threshold criteria for nutritional value may include a minimum percentage by weight of fiber content in the food product. Lastly, a minimum percentage by weight of protein content in the food product may be specified, as at block 40.

The threshold criteria may be separately defined or specified for different types of foods, such as beverages, snacks or solid foods. For example, representative threshold criteria for nutritional value are set forth in the table below:

| | Criteria for Marking with Logo | | | | | |
|---|---|---|---|---|---|---|
| | Beverages | | Foods | | Snacks | |
| Fat | ≦3 | g | 30% | of kcal | 35% | of kcal |
| Saturated Fat | ≦1 | g | ≦1 | g | ≦1 | g |
| Trans Fat | 0 | | 0 | | 0 | |
| Cholesterol | 60 | mg | 60 | mg | 60 | mg |
| Sodium | 480 | mg | 480 | mg | 270 | mg |
| Vitamin A, C, Fe, | 10% | | 10% | | Not | |
| Fiber or Protein | | | | | applicable | |
| Add Sugar | 25% | of kcal, | 25% | of kcal, | 25% | of kcal, |
| | | unless 10% | | unless 10% | | unless 10% |
| | | DV of fiber | | DV of fiber | | DV of fiber |
| Reduced Sugar | ≦25% | | ≦25% | | ≦25% | |

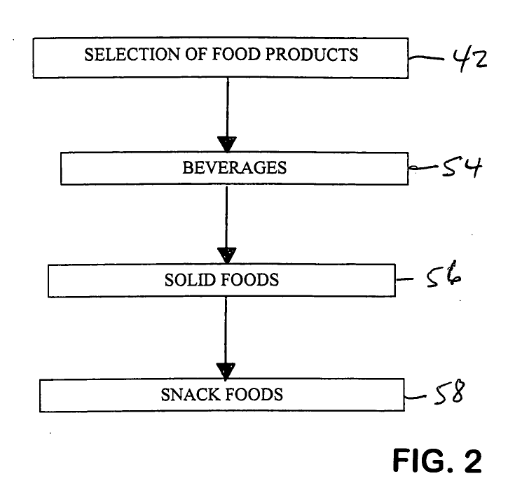

Once the threshold criteria are developed or specified, the first method contemplates applying the threshold criteria to various food products to determine which food products satisfy the threshold criteria. For example, selection of a food product for analysis at block 40 may include selection of a beverage at block 54 of FIG. 2, selection of a solid food at block 56 and/or selection of a snack food at block 58. Application of the threshold criteria of blocks 22-40 to a selected food product may be automatic, such as by a data processing system, which is further discussed below. As shown in block 42 of FIG. 1B, food products are selected for further analysis to determine if the selected food products satisfy the threshold criteria. For example, as indicated at block 44, it may be desirable to review or analyze all of the food products of a particular company to determine which of those food products satisfy all of the developed or enumerated threshold criteria, as shown at block 46.

In order to alert or to inform a consumer that a food product satisfies all of the threshold criteria for nutritional value, as determined in blocks 22-40, a distinctive logo may be applied to the food product. Preferably, the logo has some appealing design characteristics, colored features, or the like, to attract the interest of the potential purchaser or consumer, as indicated in block 48 of FIG. 1B.

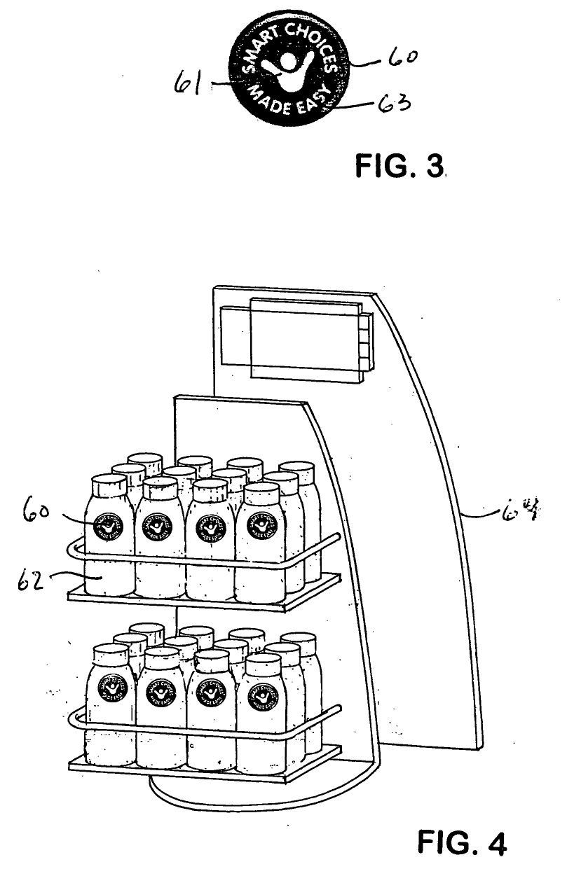

An example of such a logo 60 appears in FIG. 3. Preferably, logo 60 has some appealing design characteristics, colored features, texture, visual appearance or the like, to enhance recognition and significance of the logo by consumers in subsequent shopping experiences. For example, logo 60 may be of a different color than the adjacent color of the packaging of the food product. In addition, logo 60 optionally may contain attractive or interesting stylistic elements 61 and/or informative legends 63 such as those shown in FIG. 3.

Logo 60 may be separately affixed to a food product, printed on a label that is attached to a food product, formed in the container for the food product, or otherwise displayed on the packaging of the food product. Logo 60 is shown affixed to each food product 62 that is displayed in a display 64 in FIG. 4. Logo 60 is preferably located in any readily viewable portion of the food product 62 when the food product is in a display 64 or on a conventional grocery store shelf or the like, such as on a front portion of the packaging or display for the food product, on the cap or on an upper portion of the packaging, or the like.

When the logos 60 are applied to qualifying food products 62 that satisfy all of the requisite criteria of a selected method, the food products are distributed for sale to customers with the applied logo 60, as indicated in block 50 of FIG. 1B. The food products are then typically put on display in a store or sales environment where the logos 60 can be viewed by the consumer during selection and purchasing of the food product (block 52).

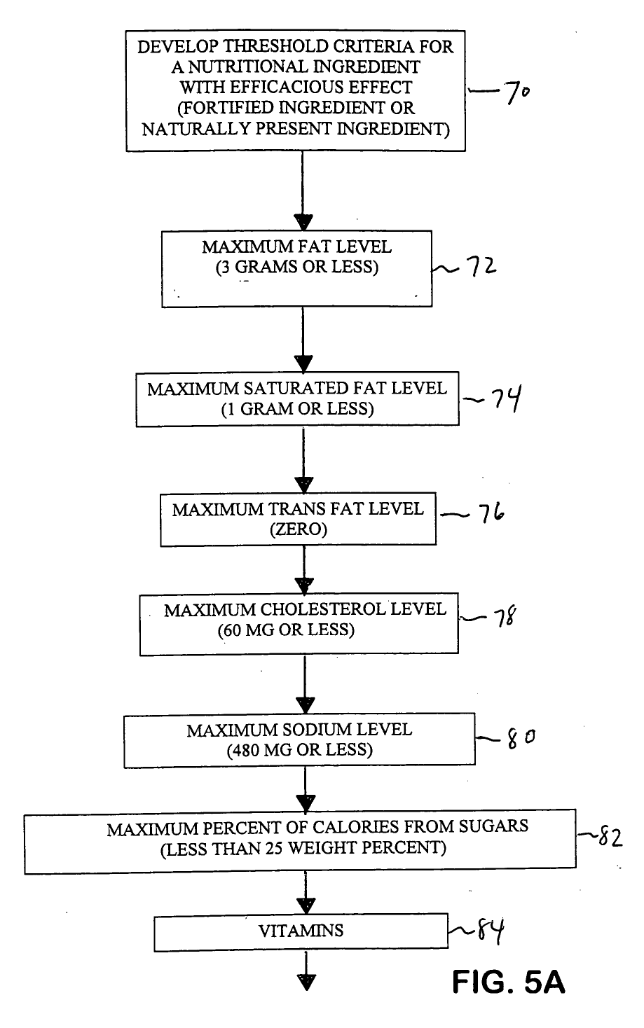

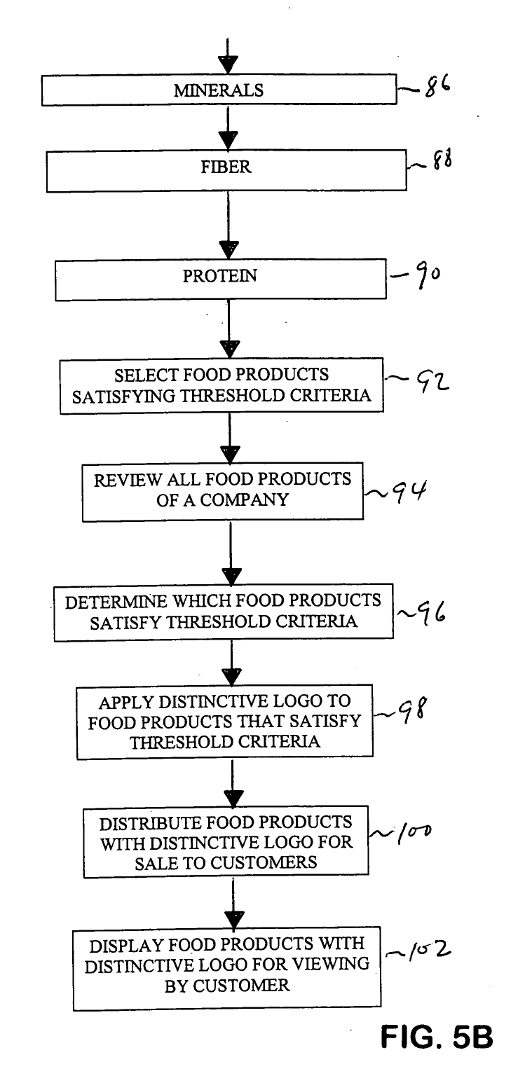

A second method of developing threshold criteria for use in analyzing food products is shown in FIGS. 5A and 5B. In this second method, the food product 62 is analyzed for at least one ingredient that provides an efficacious biological effect. Such ingredient may be a fortified ingredient or a naturally present ingredient. As with the first method beginning at block 20 of FIG. 1A, this second method beginning at block 70 may also include the nutritional value criteria utilized in the first method, if desired. Thus, blocks 72-82 may be optionally used to define maximum levels of fat level at block 72, maximum levels of saturated fat at block 74, maximum levels of trans fat at block 76, maximum level of cholesterol at block 78, maximum level of sodium at block 80 and maximum percent of calories from sugars at block 82. These maximum levels and percentages may be defined as previously discussed in the corresponding blocks 22-32 of FIG. 1A.

In accordance with the second method beginning at block 70, a minimum level of at least one nutritional ingredient that provides an efficacious effect is defined in blocks 84-90 of FIGS. 5A and 5B. For example, in block 84, all or a portion of the minimum daily requirement for one or more vitamins may be defined. One such example is a minimum of 50 percent of the minimum daily requirements for vitamin C. Of course, minimum percentages of the minimum daily requirements for any other vitamins, or for a nutrient, could additionally, or alternatively, defined. Similarly, a percentage of the minimum daily requirements for one or more minerals may be defined, such as 100 percent of the minimum daily requirement for iron.

In block 88, a minimum weight percentage of the fiber content of the food product may be defined. A minimum weight percentage of the protein in the food product may be defined, as in block 90. Of course, additional blocks could be added to FIGS. 5A and 5B to further define other or additional content of food products that provide a biologically efficacious effect.

Blocks 92 through 102 provide similar steps or operations to the blocks 42-52 of FIG. 1B that were previously discussed above. Food products are selected at block 92 for review to determine if the selected food products satisfy the nutritional criteria of blocks 72-82, if applicable, and to determine if the selected food products satisfy the efficacious effect criteria of one or more of blocks 84-90. Instead of reviewing a selected food product in block 92, the review may be of all food products of a company, as in block 94. By applying the criteria of the applicable blocks 72-90 to the food products, it is determined which food products satisfy the selected threshold criteria in block 96. A distinctive logo, such as logo 60 in FIG. 3, is applied to, or used in association with, those food products which satisfy the selected threshold criteria in block 98. The food products with the distinctive logo are then distributed for sale to customers, block 100, and are displayed for viewing by customers at the point of sale, block 102.

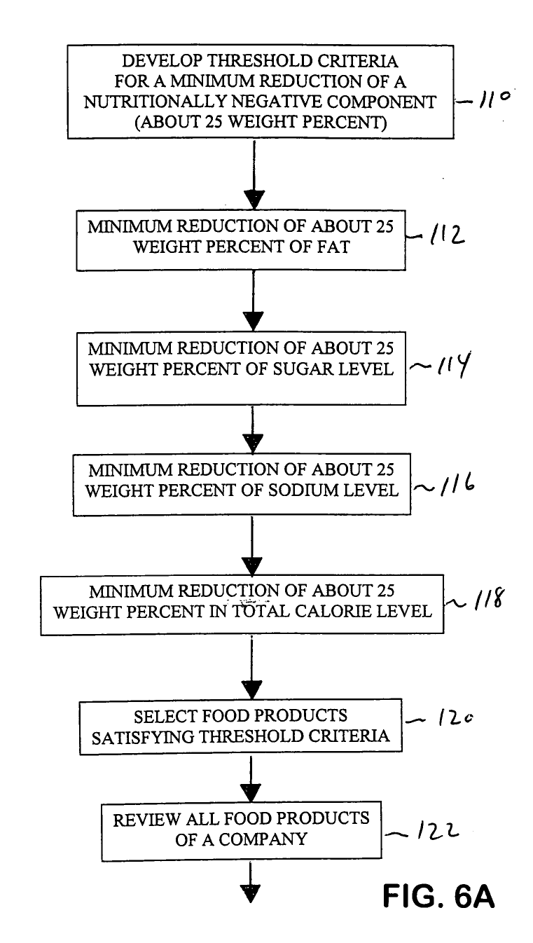

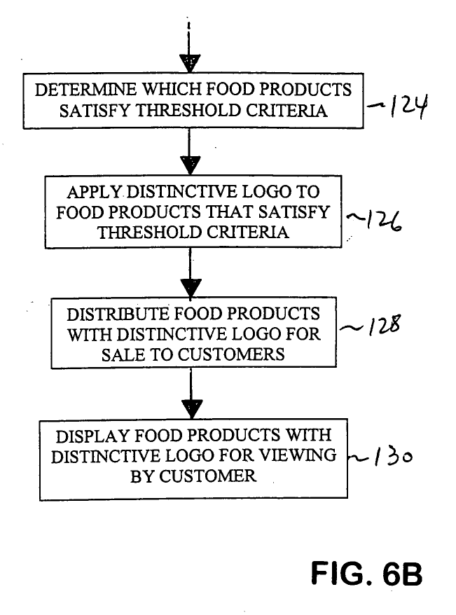

A third method of developing threshold criteria for use in analyzing food products is shown in FIGS. 6A and 6B. In this third method, threshold criteria are developed for a minimum reduction of a nutritionally negative component, such as fat content, sugar level, sodium level and/or total calorie level. Preferably, any such nutritionally negative component is reduced by about 25 percent or greater. After the threshold criteria are developed, the food product 62 is analyzed to determine if it meets such criteria. As with the first method beginning at block 20 of FIG. 1A and the second method beginning at block 70 of FIG. 5A, the third method may also analyze the food product for the nutritional value criteria utilized in the first method and/or the nutritional efficacious criteria utilized in the second method, if desired. For example, blocks 22-32 of the first method in FIG. 1A may be used to define maximum levels of fat level at block 22, maximum levels of saturated fat at block 24, maximum levels of trans fat at block 26, maximum level of cholesterol at block 28, maximum level of sodium at block 30 and maximum percent of calories from sugars at block 32. Similarly, blocks 84-90 of the second method in FIGS. 5A and 5B may be incorporated into the third method, if desired, to define or specify minimum levels of ingredients that have an efficacious effect. These maximum or minimum levels and percentages may be defined as previously discussed with respect to the first and second methods.

In the third method beginning at block 110 in FIGS. 6A and 6B, threshold criteria are developed to define a minimum reduction of a nutritionally negative component in a food product, such as a minimum reduction of about 25 weight percent. One such example is a minimum reduction of about 25 weight percent of fat in block 112. In block 114, the sugar level of the food product has a minimum reduction of about 25 weight percent in sugar level. A minimum reduction of about 25 weight percent in sodium level is specified in block 117 and a minimum reduction of about 25 weight percent is specified in block 118. Of course, any sub-combination of the criteria specified in blocks 112-118 could be developed as the testing criteria instead of the criteria in all of blocks 112-118, if desired.

Food products are selected at block 120 for review to determine if the selected food products satisfy the minimum reduction criteria of blocks 112-118, if all criteria are applicable. Instead of reviewing one or more selected food products in block 120, the review may be of all food products of a company, as in block 122. By applying the criteria of the applicable blocks 112-118 to the food products, it is determined which food products satisfy the selected threshold criteria in block 124. A distinctive logo, such as logo 60 in FIG. 3, is applied to those food products which satisfy the selected threshold criteria in block 126. The food products with the distinctive logo are then distributed for sale to customers, block 128, and are displayed for viewing by customers at the point of sale, block 130.

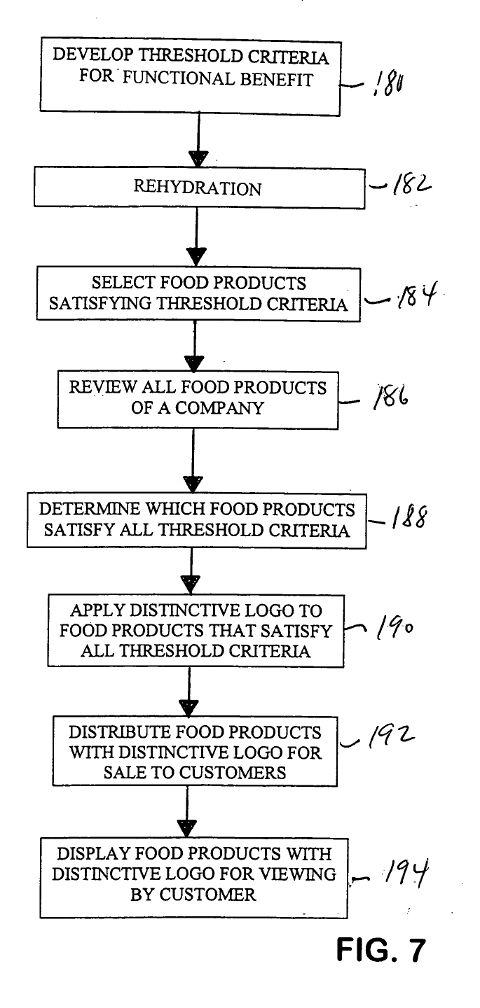

In the fourth method beginning at block 180 in FIG. 7, threshold criteria are developed to define a functional benefit in a food product. One such example is rehydration in block 182. Of course, this fourth method may also incorporate any of the criteria of the first three methods, if so desired. Food products are selected at block 184 for review to determine if the selected food products satisfy the rehydration criteria of block 184. Instead of reviewing one or more selected food products in block 184, the review may be of all food products of a company, as in block 186. By applying the criteria of the applicable block 182 to the food products, it is determined which food products satisfy the rehydration criteria in block 188. A distinctive logo, such as logo 60 in FIG. 3, is applied to those food products which satisfy the selected threshold criteria in block 190. The food products with the distinctive logo are then distributed for sale to customers, block 192, and are displayed for viewing by customers at the point of sale, block 194.

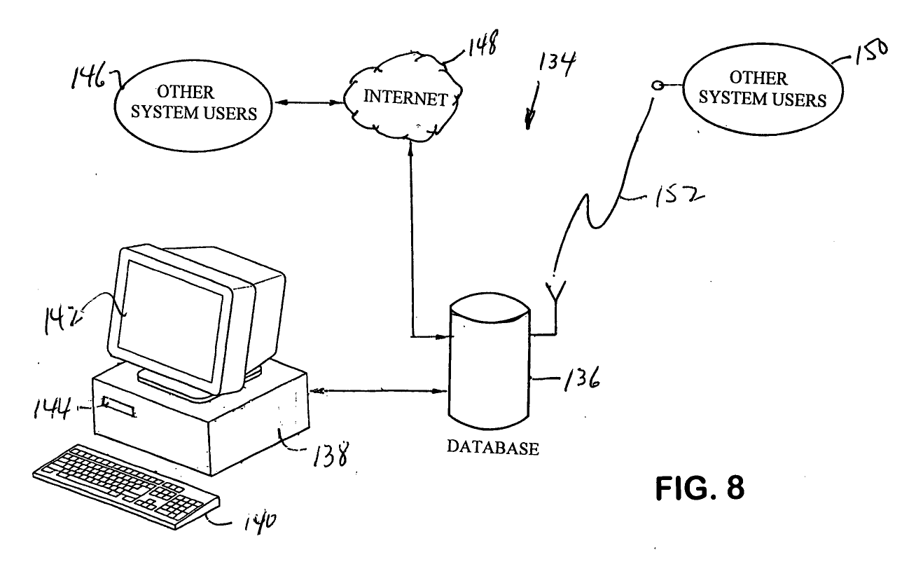

As previously mentioned, the review of food products to determine which food products meet the developed criteria, in accordance with any of the first, second, third or fourth methods presented above, may be automated. To this end, a data processing system, generally designated 134, in FIG. 8 may include a database or memory 136 and at least one computing device 138. Computing device 138 may be any data entry device such as a personal computer (PC), laptop computer, or the like. In the illustration of FIG. 8, computing device 138 includes a keyboard 140 for entering data into the database 136 and for initiating food product reviews. Database 138 may be internet or intranet accessible for utilization by multiple users. If database 138 is internet accessible, consumers may be permitted access to see which food products satisfy the criteria of any of the methods presented above. A display monitor 142 may depict the data and instructions entered and the results of the reviews or analyses.

For example, the criteria to be used in analyzing the food products, the information on the types of food products available for analysis and information on the ingredients in the food products may be entered on keyboard 140, read off of a CD that may be inserted into a CD drive 144 or transferred from any other data storage medium. Other means of entering criteria and information into the database, and for initiating food product review or analysis, may also be employed, as desired.

Other system users 146 may participate in formulating criteria for the various methods employed, enter data concerning food products, initiate food product reviews and/or review the results of analyses with computing devices, such as computing device 138, via the internet 136. Still other system users 150 may similarly communicate with database 136 via a wireless link 152, such as a wireless local area network (LAN) that is compatible, for example, with the IEEE 802.11 Wi-Fi specification. Still other wireless links 152 may be provided by radio frequency transmission, satellite links and the like.

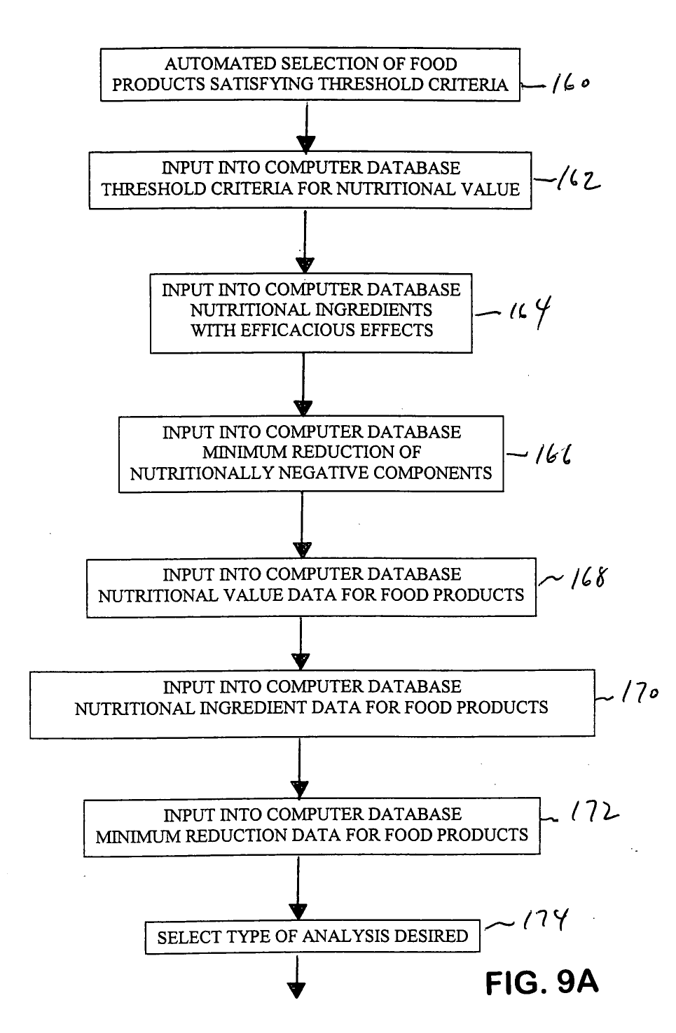

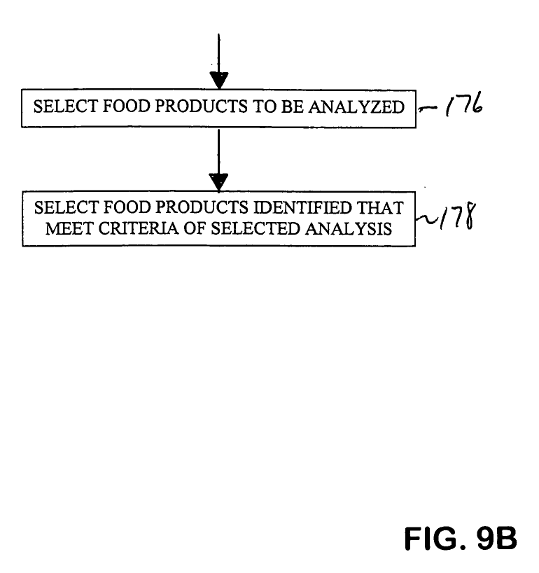

Beginning at block 160, FIGS. 9A and 9B illustrate typical steps that may be employed in the data processing system 134 of FIG. 8 to automate the review and analysis of a food product with selected criteria that are developed in accordance with the first, second, third or fourth methods. In block 162, the threshold criteria that were developed for nutritional value in accordance with the first method are input into the database 136 for storage, and for recall during review or analysis of selected food products. Similarly, in blocks 164 and 166, criteria developed for nutritional ingredients with efficacious effects in accordance with the second method and criteria developed for a minimum reduction of nutritionally negative components in accordance with the third method are input into the database 136.

Next, in blocks 168-172, corresponding information about selected food products, or all of the food products of a company, are input into database 136, including nutritional value data for each food product in block 168, nutritional value data for each food product in block 170 and minimum reduction data for each food product in block 172. Of course, not all of the above information need be entered into database 136 if any selected food product is to be reviewed for less than all three methods. The type of analysis desired (first method, second method, third method, fourth method or any combination of the four methods) is selected at block 174, which may be initiated by an entry on keyboard 140 in FIG. 8. Those food products to be reviewed or analyzed in accordance with the selected methods are selected in block 176. In block 178, those food products that meet the criteria of the first, second, third or fourth methods are then identified or selected for application of the distinctive logo. For example, the food products 62 that meet the criteria of any of the selected methods may be displayed on display monitor 142 of computing device 138.

Then, in accordance with the selected methods, the distinctive logo 60 is applied to the food products 62 which are then distributed and displayed with the distinctive logo for sale to consumers, as previously discussed in connection with the three methods presented above. Logos 60 may be of different colors to indicate that the food product satisfies the criteria of different methods, such as green for the nutritional value of the first method, red for ingredients having the efficacious effect of the second method, yellow for satisfying the minimum reduction of nutritionally negative component criteria of the third method or blue for satisfying the functional benefit of the fourth method. Thus, more than one logo 60 may be applied to a food product that meets the criteria of more than one method, if so desired.

Of course, other criteria may be developed for analyzing and reviewing food products to determine if the food products are eligible for application of the distinctive logo that consumers will learn to associate with a healthful food product. Similarly, other methods of utilizing the criteria to determine if a food product is eligible for application of the distinctive logo may be formulated.

While particular embodiments of the invention have been shown and described, it will be obvious to those skilled in the art that changes and modifications may be made therein without departing from the invention in its broader aspects.

1. A method for providing consumers with nutritional value information, said method comprising the steps of:
developing threshold criteria for nutritional value information, said threshold criteria including a maximum fat level, a maximum saturated fat level, a maximum trans-fat level, a maximum cholesterol level, a maximum sodium level, and a maximum percentage of calories from sugars;
selecting food products exhibiting all of said threshold criteria, said food products being selected from among products of a company;
applying a distinctive logo to said food products that exhibit said threshold criteria to provide a plurality of nutritional value food products; and
distributing said nutritional value food products for displaying same in retail store outlets with said distinctive logo being visible to retail consumers.

2. The method for providing consumers with nutritional value information as defined in claim 1 wherein the step of selecting food products includes selection from the group consisting of beverages, solid foods and snack foods.

3. The method for providing consumers with nutritional value information as defined in claim 1 wherein the step of selecting food products is automated.

4. The method for providing consumers with nutritional value information as defined in claim 1 wherein the step of developing threshold criteria includes the step of developing a maximum fat level criteria selected from the group consisting of (a) containing about 3 grams of fat or less and (b) having not more than about 35 weight percent of its calories from fat, based upon the total calories provided by the food product.

5. The method for providing consumers with nutritional value information as defined in claim 1 wherein the step of developing threshold criteria includes the step of using a maximum saturated fat level of less about 1 gram or less of saturated fat.

6. The method for providing consumers with nutritional value information as defined in claim 1 wherein the step of developing threshold criteria includes the step of using a maximum trans-fat level of zero.

7. The method for providing consumers with nutritional value information as defined in claim 1 wherein the step of developing threshold criteria includes the step of using a maximum cholesterol level of 60 milligrams or less of cholesterol.

8. The method for providing consumers with nutritional value information as defined in claim 1 wherein the step of developing threshold criteria includes the step of using a maximum sodium level of 480 milligrams or less of sodium.

9. The method for providing consumers with nutritional value information as defined in claim 1 wherein the step of developing threshold criteria includes the step of using a maximum percentage of calories from sugar of not more than about 25 weight percent of the calories of the food product being from sugar, based upon the total calories provided by the food product.

10. The method for providing consumers with nutritional value information as defined in claim 1 wherein the step of developing threshold criteria includes vitamins, minerals, fiber, protein, or combinations thereof.

11. A method for providing consumers with nutritional value information, said method comprising the steps of:
developing threshold criteria for nutritional value information for food products, said threshold criteria being that the food product includes a nutritional ingredient selected from the group consisting of fortified ingredients and ingredients naturally present in the food product, said nutritional ingredient being proved to be efficacious in delivering a functional benefit when ingested;
selecting food products exhibiting said threshold criteria, said food products being selected from among products of a company;
applying a distinctive logo to said food products that exhibit said threshold criteria to provide a plurality of nutritional value food products; and
distributing said nutritional value food products for displaying same in retail store outlets with said distinctive logo being visible to retail consumers.

12. The method for providing consumers with nutritional value information as defined in claim 11 wherein the step of selecting food products includes selection from the group consisting of beverages, solid foods and snack foods.

13. The method for providing consumers with nutritional value information as defined in claim 11 wherein the step of selecting food products is automated.

14. The method for providing consumers with nutritional value information as defined in claim 11 wherein the step of developing threshold criteria includes the step of developing a maximum fat level criteria selected from the group consisting of (a) containing about 3 grams of fat or less and (b) having not more than about 35 weight percent of its calories from fat, based upon the total calories provided by the food product.

15. The method for providing consumers with nutritional value information as defined in claim 11 wherein the step of developing threshold criteria includes the step of using a maximum saturated fat level of less about 1 gram or less of saturated fat.

16. The method for providing consumers with nutritional value information as defined in claim 11 wherein the step of developing threshold criteria includes the step of using a maximum trans-fat level of zero.

17. The method for providing consumers with nutritional value information as defined in claim 11 wherein the step of developing threshold criteria includes the step of using a maximum cholesterol level of 60 milligrams or less of cholesterol.

18. The method for providing consumers with nutritional value information as defined in claim 11 wherein the step of developing threshold criteria includes the step of using a maximum sodium level of 480 milligrams or less of sodium.

19. The method for providing consumers with nutritional value information as defined in claim 11 wherein the step of developing threshold criteria includes the step of using a maximum percentage of calories from sugar of not more than about 25 weight percent of the calories of the food product being from sugar, based upon the total calories provided by the food product.

20. The method for providing consumers with nutritional value information as defined in claim 11 wherein the step of developing threshold criteria includes vitamins, minerals, fiber, protein, or combinations thereof.

21. A method for providing consumers with nutritional value information, said method comprising the steps of:
developing threshold criteria for nutritional value information, said threshold criteria being a minimum reduction in a nutritionally negative component selected from the group consisting of fat level, sugar level, sodium level, total calorie level, and combinations thereof, each minimum level being reduced when compared with a base product which is formulated with a traditional level of said nutritionally negative component;
selecting food products exhibiting at least one of said threshold criteria, said food products being selected from among products of a company;
applying a distinctive logo to said food products that exhibit said threshold criteria to provide a plurality of nutritional value food products; and
distributing said nutritional value food products for displaying same in retail store outlets with said distinctive logo being visible to retail consumers.

22. The method for providing consumers with nutritional value information as defined in claim 21 wherein the step of selecting food products includes selection from the group consisting of beverages, solid foods and snack foods.

23. The method for providing consumers with nutritional value information as defined in claim 21 wherein the step of selecting food products is automated.

24. The method for providing consumers with nutritional value information as defined in claim 21 wherein the step of developing threshold criteria includes the step of using a minimum reduction in the nutritionally negative component of about 25 percent, based on the total nutritionally negative component present in the base product.

25. The method for providing consumers with nutritional value information as defined in claim 21 wherein the step of developing threshold criteria includes the step of using a minimum reduction in fat level of about 25 weight percent, based on the total weight of fat in the base product.

26. The method for providing consumers with nutritional value information as defined in claim 21 wherein the step of developing threshold criteria includes the step of using a minimum reduction in sugar level of about 25 weight percent, based on the total weight of sugar in the base product.

27. The method for providing consumers with nutritional value information as defined in claim 21 wherein the step of developing threshold criteria includes the step of using a minimum reduction in sodium level of about 25 weight percent, based on the total weight of sodium in the base product.

28. The method for providing consumers with nutritional value information as defined in claim 21 wherein the step of developing threshold criteria includes the step of using a minimum reduction in total calorie level of about 25 weight percent, based on the total calories delivered by the base product.
